(19) United States
(12) Patent Application Publication
(10) Pub. No.: US 2008/0024894 A1
(43) Pub. Date: Jan. 31, 2008

(54) Magnetic recording and reproducing device

(75) Inventor: Yuichiro Yamazaki, Kawasaki (JP)

Correspondence Address: KRATZ, QUINTOS & HANSON, LLP, 1420 K Street, N.W., Suite 400, WASHINGTON, DC, 20005, US

(73) Assignee: FUJITSU LIMITED, Kawasaki (JP)

(21) Appl. No.: 11/905,012

(22) Filed: Sep. 27, 2007

Related U.S. Application Data
(63) Continuation of application No. PCT/JP05/06185, filed on Mar. 30, 2005.

(51) Int. Cl. G11B 27/36

(52) U.S. Cl. 360/31; 324/210

(57) ABSTRACT

This invention provides a magnetic recording and reproducing device, having a recording media with a diagnostic area to which diagnostic data is written, and a computation unit having a program area which determines the possibility of erroneous reading of data read out from the recording media and a memory area which stores diagnostic data and a threshold value for the possibility of erroneous reading. The computation unit writes diagnostic data to the diagnostic area of the recording media, reads out diagnostic data written to the diagnostic area of the recording media a plurality of times with time intervals, determines the possibility of erroneous reading of the read-out diagnostic data upon each reading-out, and estimates whether the possibility of erroneous reading after a prescribed time has elapsed exceeds the threshold value based on a plurality of possibilities of erroneous reading and times of reading-out.

### CROSS REFERENCE TO RELATED APPLICATIONS

This application is a continuation of International Application No. PCT/JP2005/006185, filed on Mar. 30, 2005, now pending, herein incorporated by reference.

### TECHNICAL FIELD

This invention relates to a magnetic recording and reproducing device which evaluates data degradation due to thermal relaxation.

### BACKGROUND ART

A magnetic recording and reproducing device rotates a magnetic disk, having a ferromagnetic material, and performs recording and reproducing of information by scanning a magnetic head over the magnetic disk; such devices are generally used as auxiliary storage devices in computers.

At present, many magnetic recording and reproducing devices have self-diagnostic functions in a SMART (Self-Monitoring, Analysis and Reporting Technology System) mechanism. By monitoring information obtained from this mechanism, there is the possibility of advance prevention of malfunctions of a magnetic disk recording and reproducing device.

Technology of this kind includes for example the invention disclosed in Japanese Patent Laid-open No. 2004-62975. In this invention, as means of diagnosing the characteristics of the recording media, characteristics are measured when recording or reproducing data in a recording and reproducing device and are combined with past diagnostic history information, and the period in which magnetic media characteristics will become equal to or less than a prescribed value is anticipated, and the user is notified.

One characteristic of recording media is the phenomenon of thermal relaxation, as a result of which reading of data written to recording media becomes difficult with the passage of time. Here thermal relaxation means disordering of magnetization states, with instability and irregularity of recording magnetization, especially the influence of the ambient temperature on this phenomenon is particularly large.

In recent years, magnetic particles have grown smaller in size accompanying higher recording media densities, and there has been the problem that magnetization inversion occurs easily and the performance of recording media is degraded due to thermal relaxation. Such thermal relaxation phenomena are known to depend heavily on the write characteristics of the magnetic head and on the recording characteristics of the recording media, but maintaining all these parameters satisfactorily is difficult. If the coercive force of the recording media is made high, thermal relaxation does not readily occur, but writing becomes difficult. In magnetic recording and reproducing devices, it is necessary to strike a balance between the magnetic head write characteristics and the recording media recording characteristics on one hand, and the extent of thermal relaxation on the other, and optimum values of these parameters must be determined.

In Japanese Patent Laid-open No. 10-255202, when in a state in which recorded signals are attenuated due to thermal relaxation, write recording is again performed, prior to the occurrence of errors, in order to suppress the effect of thermal relaxation. According to the technology of Japanese Patent Laid-open No. 10-255202, measurements are performed in a short period at the time of manufacture, and no judgment is made as to whether reliability can be maintained after a long period of time has elapsed.

However, in the case of such technology, if data loss occurs prior to data re-writing, then data re-writing cannot be performed.

Hence an object of this invention is to provide a magnetic recording and reproducing device which performs monitoring of thermal relaxation in recording media and enables prediction of the period of data loss, in order to prevent loss of recorded data in advance.

### DISCLOSURE OF THE INVENTION

Further, in the above first aspect of the present invention, the computation unit performs the diagnostic data writing at the time power is turned on.

Further, in the above first aspect of the present invention, the computation unit reads the diagnostic data after a prescribed time has elapsed from the diagnostic data writing.

Further, in the above first aspect of the present invention, the computation unit writes a time stamp indicating the writing time to the diagnostic area when writing the diagnostic data, and when reading out the diagnostic data, writes, to the diagnostic area, the time stamp indicating the time of reading-out and the possibility of erroneous reading of the diagnostic data read.

Further, in the above first aspect of the present invention, the computation unit has a threshold value for the possibility of erroneous reading, and compares the possibility of erroneous reading of read-out diagnostic data with the threshold value, and when the possibility of erroneous reading of the read-out diagnostic data is equal to or greater than the threshold value, records, in the diagnostic area, the fact that the possibility of erroneous reading of the read-out diagnostic data is equal to or greater than the threshold value.

Further, in the above first aspect of the present invention, the computation unit has a threshold for the possibility of erroneous reading, the possibility of erroneous reading for read-out diagnostic data is compared with the possibility of erroneous reading of diagnostic data written to the diagnostic area and with the threshold value, and when after a prescribed time has elapsed the possibility of erroneous reading of diagnostic data is judged to equal or exceed the threshold value, the fact that the possibility of erroneous reading of diagnostic data after the prescribed time has elapsed is equal to or greater than the threshold value is recorded in the diagnostic area.

Further, in the above first aspect of the invention, the computation unit has a temperature sensor which supplies temperature information, and computation unit changes the threshold value based on the temperature information supplied from the temperature sensor.

Further, in the above first aspect of the present invention, the computation unit has a temperature sensor which supplies temperature information, when the diagnostic data is read out, the temperature information is written to the diagnostic area, and the threshold value is changed based on the written temperature information.

In order to resolve the above problems, a data recording and reproducing device of the first aspect of the present invention has a recording media with a diagnostic area to which diagnostic data is written, and a computation unit having a program area which determines the possibility of erroneous reading of data read-out from the recording media and a memory area which stores the diagnostic data and a threshold value for the possibility of erroneous reading, wherein the computation unit writes the diagnostic data to the diagnostic area of the recording media, reads out of the diagnostic data written to the diagnostic area of the recording media at a plurality of times with time intervals, determines the possibility of erroneous reading of the read-out diagnostic data upon each read-out, and estimates whether the possibility of erroneous reading has elapsed exceeds the threshold value after a prescribed time based on a plurality of possibilities of erroneous reading and the times of read-out.

In the above first aspect of the present invention, the computation unit performs writing of the diagnostic data at the time of shipment from the factory.

In the above first aspect of the present invention, the computation unit performs writing of the diagnostic data at the time power is turned on.

In the above first aspect of the present invention, at the time of read-out of the diagnostic data, the computation unit writes a time stamp indicating the read-out time and the possibility of erroneous reading of the read-out diagnostic data to the diagnostic area.

In the above first aspect of the present invention, the computation unit records, on the recording media, the fact that the possibility of erroneous reading of the diagnostic data is equal to or greater than the threshold value after the prescribed time has elapsed, if the possibility of erroneous reading of the diagnostic data is estimated to be equal to or greater than the threshold value after the prescribed time has elapsed.

In the above first aspect of the present invention, the computation unit further has a temperature sensor which supplies temperature information, wherein the computation unit changes the threshold value based on the temperature information supplied from the temperature sensor.

In the above first aspect of the present invention, the computation unit further has a temperature sensor which supplies temperature information, the computation unit writes the temperature information to the diagnostic area when the diagnostic data is read out, and changes the threshold value based on the written temperature information.

A magnetic recording and reproducing device of this invention periodically monitors thermal relaxation, and judges whether recorded data may be easily lost. By this means, loss of data written in the magnetic recording and reproducing device can be prevented in advance, and reliability can be improved.

### BRIEF DESCRIPTION OF THE DRAWINGS

FIG. 1 is a block diagram of the magnetic recording device of an aspect of the invention;

FIG. 2 is a flowchart of thermal relaxation judgment in an aspect;

FIG. 3 represents a linear approximating equation for thermal relaxation;

FIG. 4 is an example of the change in ambient temperature with the passage of time; and

FIG. 5 shows the VM threshold value versus the average ambient temperature.

### BEST MODE FOR CARRYING OUT THE INVENTION

Below, aspects of the present invention are explained referring to the drawings. However, the technical scope of the present invention is not limited to these aspects, but extends to the present inventions described in the Scope of Claims, and to inventions equivalent thereto.

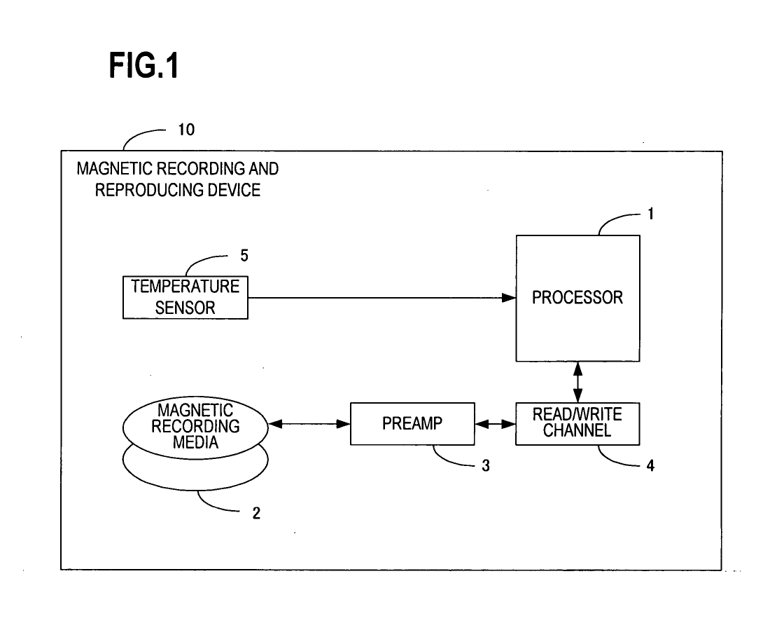

FIG. 1 is a block diagram of the magnetic recording device of an aspect of the present invention. The magnetic recording device 10 of this aspect has a processor 1 which controls the entire magnetic recording device, a read/write channel 4 which performs modulation and demodulation of write data and read-out data, a preamp 3 which amplifies write signals and read-out signals, magnetic recording media 2 on which data is recorded, and a temperature sensor 5 which supplies temperature information to the processor 1. The processor 1 has a memory area which holds diagnostic data for use in judging thermal relaxation, and a program area to determine the possibility of erroneous reading from diagnostic data read out from the magnetic recording media.

During ordinary data writing, data for writing and an address are received from a host computer connected to the magnetic recording device 10, the head position is confirmed by means of servo information on the magnetic recording media 2, and the write data is written to the target address via the read/write channel 3 and preamp 4.

During ordinary data reading, the magnetic recording device 10 receives an address from the host computer, the head position is confirmed by means of servo information on the magnetic recording media 2, and data is read at the target address. The read-out data signals are amplified by the preamp 3 and are demodulated in the read/write channel 4.

Here, judgment of thermal relaxation in the magnetic recording media 2 is explained.

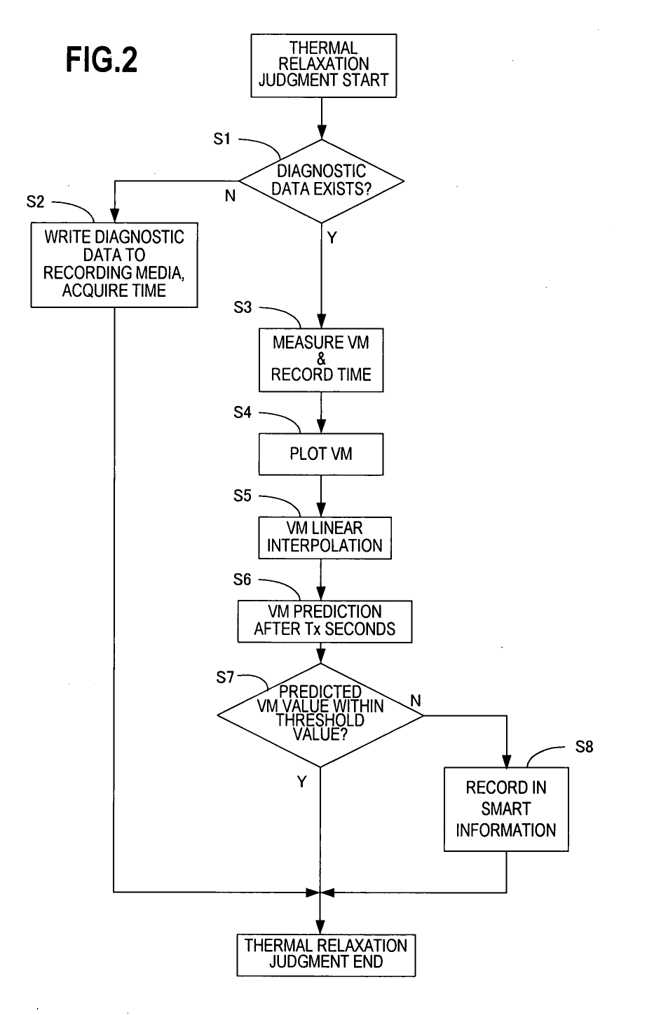

FIG. 2 is a flowchart of thermal relaxation judgment in this aspect. Thermal relaxation judgment is performed at the time of factory shipment, turning on of the power, or at other times. When thermal relaxation judgment is begun, the processor 1 judges whether thermal relaxation diagnostic data exists on the magnetic recording media 2 (step S1). Normally the diagnostic data, which is an arbitrary bit series, is written at the time of factory shipment to a system area or other dedicated diagnostic area provided on the magnetic recording media 2. At the time of writing, a writing time stamp is also written to the diagnostic area.

In step S1, when it is judged that thermal relaxation diagnostic data does not exist, the processor 1 writes diagnostic data stored in the memory area of the processor 1 to the system area of the magnetic recording media 2 (step S2). Simultaneously, the processor 1 acquires a time, and also writes a time stamp for the time of writing to the diagnostic area. When writing is completed, the thermal relaxation judgment processing ends.

When thermal relaxation diagnostic data exists on the magnetic recording media, reading out of the written diagnostic data is performed, and the possibility of erroneous reading of the read-out diagnostic data is calculated (step S3). The possibility of erroneous reading is here a value representing signal quality, such as the VM (Viterbi margin), ER (error rate), or S/N (signal-to-noise ratio). In this aspect, the VM is used in explanations. The calculated VM and a time stamp for the time of calculation are written to the diagnostic area.

In the field of magnetic recording, the Viterbi decoding method is widely used as a method for judging whether there are errors in received data. The Viterbi decoding method is a (maximum-likelihood) decoding method in which inferred values and actually received data are compared for a path of 0/1 series data, and the code thought to be most correct is determined as the read-out value. The VM was conceived as a means of measuring signal quality in Viterbi decoding, and is a method in which the differences (margins) between the path of received data and the paths closest to this path are determined, and the number of paths for which the margin is smaller than a certain threshold is counted.

Here we return to FIG. 2. After step S3, the calculated VM is plotted together with the VM values previously written to the diagnostic area (step S4). At this time the vertical axis shows logarithmic VM values, and the vertical axis shows logarithmic values of the times of VM calculation.

Then, based on the plotted VM values, linear interpolation is performed (step S5). Prior to explaining the actual linear interpolation, an explanation is given for a general equation (X,Y).

When expressed in the form Y=log(VM) and X=log(t), the general first-order equation Y=A×X+B is obtained. If log(VM) for X1=log(t1) and X2=log(t2) are respectively Y1 and Y2, then Y2−Y1=A(X2−X1), and A (the slope)=(Y2−Y1)/(X2−X1); hence the value of Y at time X is
Y=(Y2−Y1)/(X2−X1)×(X−X1)+Y1 (1)

Here, VM=VM−t1 at time t1, and VM=VM_t2 at time t2. Y at time T is
Y=(log(VM_{—}t2)−log(VM_{—}t1))/(log(t2)−log(t1))×(X−log(t1))+log(VM_{—}t1) (2)

Substituting specific values for head a and for head b, let the VM of head a and the VM of head b at T1=1000 s be VM_t1a and VM_t1b; similarly at time t2=10000 s, the VM of head a and the VM of head b are VM_t2a and VM_t2b respectively.

When measurements are performed with the results that VM_t1a=250, VM_t1b=450, VM_t2a=300, VM_t2b=700, the results can be represented by the linear approximating equations
Y=(log 300−log 250)/(log 10000−log 1000)×(log Tx−log 1000)+log 250 (3)
for head a, and
Y=(log 700−log 450)/(log 10000−log 1000)×(log Tx−log 1000)+log 450 (4)

for head b.

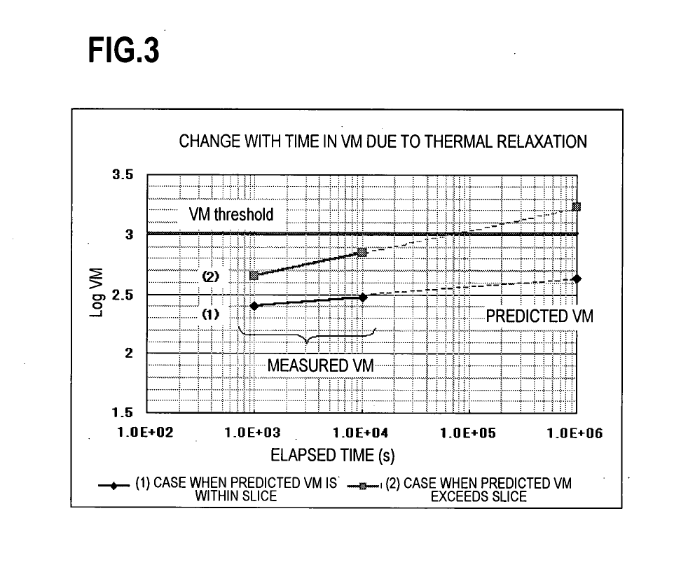

FIG. 3 shows linear approximating equations for thermal relaxation. In FIG. 3, the lines 1 and 2 represent linear approximating equations determined for the two different heads a and b described above. By substituting the number of seconds equivalent to the number of years elapsed as Tx, the anticipated VM value after the relevant number of years have elapsed can be determined (step S6).

A judgment is performed as to whether the anticipated VM value determined in step S6 is within the VM threshold value of the processor 1 (step S7). The VM threshold value depends on temperature information acquired by the temperature sensor 5.

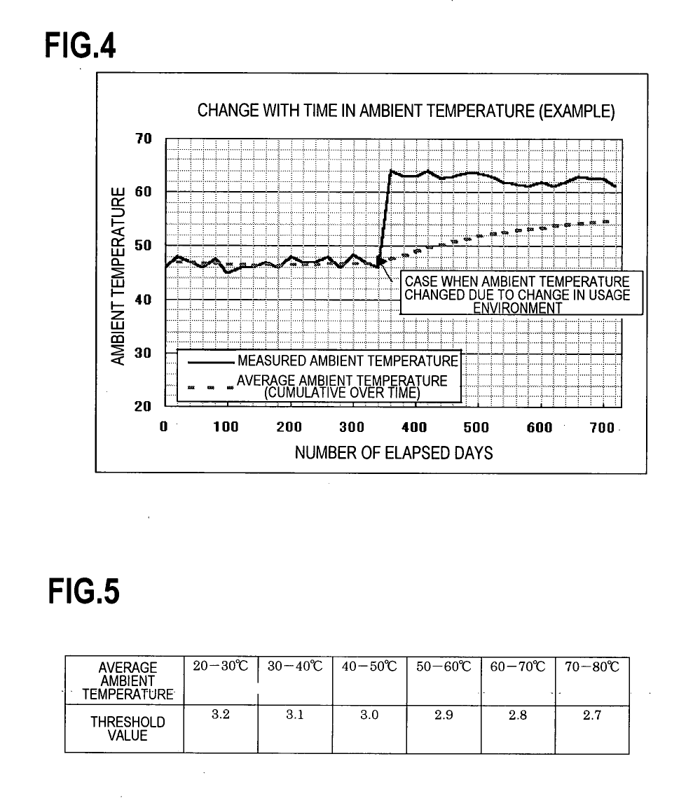

FIG. 4 is an example of changes in ambient temperature with the passage of time. Here, the ambient temperature monitoring interval can be varied. This example shows a case in which the ambient temperature is plotted every 20 days over a period of two years (730 days). The average value of the ambient temperature is indicated by a dashed line. The large change in ambient temperature near the 360th day in this figure accompanies a change in the usage environment of the magnetic recording and reproducing device. As a result of the large change in ambient temperature near the 360th day, the average ambient temperature also rises.

FIG. 5 shows VM threshold values for average ambient temperatures. Because the average ambient temperature value over the cumulative operating time from day 0 to day 360 is 40 to 50° C., the VM threshold value is 3.0. After day 360, when the ambient temperature rises, the average ambient temperature over the cumulative operating time up to day 440 exceeds 50° C., and so the VM threshold value is 2.9.

In step S7, when the anticipated VM value is within the threshold value, thermal relaxation judgment ends. When the anticipated VM value exceeds the threshold, this fact is written to the corresponding area, and thermal relaxation judgment ends. A SMART mechanism reads this area, recognizes that the anticipated VM value has exceeded the threshold value, and performs a judgment to increase the write current, or similar.

In this way, in a magnetic recording and reproducing device of the present invention, thermal relaxation is periodically monitored, and a judgment is performed as to whether recorded data may be easily lost. By this means, loss data written in the magnetic recording and reproducing device can be prevented in advance, and reliability can be improved.

### INDUSTRIAL APPLICABILITY

By means of this invention, thermal relaxation is periodically monitored, and judgments as to whether data written in a magnetic recording and reproducing device may be easily lost are performed, so that loss of written data can be prevented in advance.

1. A magnetic recording and reproducing device, comprising:
recording media having a diagnostic area to which diagnostic data is written; and
a computation unit, having a program area which determines the possibility of erroneous reading of data read-out from the recording media and a memory area which stores the diagnostic data and a threshold value for the possibility of erroneous reading, wherein
the computation unit writes the diagnostic data to the diagnostic area of the recording media, reads out of the diagnostic data written to the diagnostic area of the recording media at a plurality of times with time intervals, determines the possibility of erroneous reading of the read-out diagnostic data upon each reading out, and estimates whether the possibility of erroneous reading exceeds the threshold value after a prescribed time has elapsed based on a plurality of the possibilities of erroneous reading and times of read-out.

2. The magnetic recording and reproducing device according to claim 1, wherein the computation unit writes the diagnostic data at the time of factory shipment.

3. The magnetic recording and reproducing device according to claim 1, wherein the computation unit writes the diagnostic data at the time power is turned on.

4. The magnetic recording and reproducing device according to claim 1, wherein the computation unit writes a time stamp indicating the time of read-out and the possibility of erroneous reading of the read-out diagnostic data to the diagnostic area, at the time of read-out of the diagnostic data.

5. The magnetic recording and reproducing device according to claim 1, wherein the computation unit writes the fact that the possibility of erroneous reading of the diagnostic data is equal to or greater than the threshold value after the prescribed time has elapsed on the recording media, when the possibility of erroneous reading of the diagnostic data is estimated to be equal to or greater than the threshold value after the prescribed time has elapsed.

6. The magnetic recording and reproducing device according to claim 1, further comprising a temperature sensor which supplies temperature information to the computation unit, wherein
the computation unit changes the threshold value based on the temperature information supplied from the temperature sensor.

7. The magnetic recording and reproducing device according to claim 1, further comprising a temperature sensor which supplies temperature information to the computation unit, wherein
the computation unit writes the temperature information to the diagnostic area when reading out the diagnostic data, and changes the threshold value based on the written temperature information.
